(19) United States
(12) Patent Application Publication
(10) Pub. No.: US 2007/0078795 A1
(43) Pub. Date: Apr. 5, 2007

(54) METHOD OF OBTAINING A FRANKING CREDIT VIA A TELECOMMUNICATIONS NETWORK

(75) Inventor: Fabien Chatte, Nogent Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/470,848

(22) Filed: Sep. 7, 2006

(30) Foreign Application Priority Data
Sep. 9, 2005 (FR) 0509183

(51) Int. Cl. G06F 17/00

(52) U.S. Cl. 705/403

(57) ABSTRACT

Method of obtaining a franking credit including the following operations: entry via a user's portable communications device (10) of a unique identification number (12A) carried by a mail item (12) to be sent, entry of a franking credit at the portable communications device and transmission of the franking credit thus requested to a franking credits delivery server (16), debiting the user's account by an amount corresponding to the franking credit requested and transmission by the franking credits delivery server of a debit confirmation to the user's portable communications device, and depositing the mail item in a post box (14).

### TECHNICAL FIELD

The present invention relates exclusively to the field of mail processing and more particularly it concerns a method of obtaining a franking credit via a telecommunications network.

### PRIOR ART

Today, when a private individual or a very small enterprise (VSE) not in possession of a franking machine wishes to frank mail, it is necessary, optionally after weighing, to affix a stamp onto each envelope or package to be sent. An alternative, which does not, however, apply to packages, can consist in purchasing pre-franked envelopes but these relate only to mailings at the standard basic tariff.

There is a need, which is currently not being met, for a more universal method of obtaining a franking credit, applicable both to envelopes and packages and which avoids the abovementioned drawbacks, particularly one that can be accessed by anyone 24 hours a day, 365 days a year, and which is particularly simple to put into effect.

### DISCLOSURE OF THE INVENTION

The object of the present invention is, therefore, a novel method of obtaining a franking credit, including the following operations:
entry via a user's portable communications device of a unique identification number carried by a mail item in the user's possession,
entry of a franking credit at the portable communications device and transmission of the franking credit thus requested to a franking credits delivery server,
debiting the user's account by an amount corresponding to the franking credit requested and transmission by the franking credits delivery server of a debit confirmation to the user's portable communications device, and
depositing the mail item in a post box.

Thus, the use of a simple portable telephone makes it possible to obtain at any time, and therefore independently of post office opening hours, a franking credit enabling automatic payment of any franking service.

Depending on the embodiment envisaged, the operation of entering said unique identification number can include either a manual entry via the keypad of the portable communications device of a string of alphanumeric characters printed on the mail item and forming the unique identification number, or a digital capture by the portable communications device of a barcode printed on the mail item, said barcode preferably being a two-dimensional code selected from the following codes: Aztec code, Codablock, Code one, Code 16K, Code 49, data matrix, PDF 417, QR Code, Supercode, or a reading/interrogation by the portable communications device of an RFID tag carried by the mail item or its contents.

Preferably, the operation of sending a franking credit to the franking credits delivery server from the portable communications device includes the transmittal of an SMS message including the requested franking credit.

Advantageously, the operation of debiting the user's account includes a check of available funds in the user's account at the franking credits delivery server or a check of the user's telephone credit at a server of the user's telephone operator.

Preferably, the operation of sending a debit confirmation to the user's portable communications device from the franking credits delivery server includes the transmittal of an SMS message including the debited amount of the franking credit requested.

The invention also relates to a portable communications device intended to put into effect the method of obtaining a franking credit advantageously comprising one of the following devices: a mobile or portable telephone, a web-enabled personal digital assistant, a web-enabled portable computer.

The invention also relates to a computer program including code instructions for performing the steps of the method of obtaining a franking credit when it is executed on the portable communications device.

### BRIEF DESCRIPTION OF THE DRAWINGS

Other characteristics and advantages of the present invention will become more clearly apparent from the following description, provided for information and non limitative of the invention, in reference to the attached drawings, in which:

FIG. 1 depicts an example of a network architecture enabling the implementation of the method of delivering a franking service according to the invention, and

FIG. 2 is a block diagram illustrating the different steps of the method implemented on the network in FIG. 1.

### EMBODIMENT(S) OF THE INVENTION

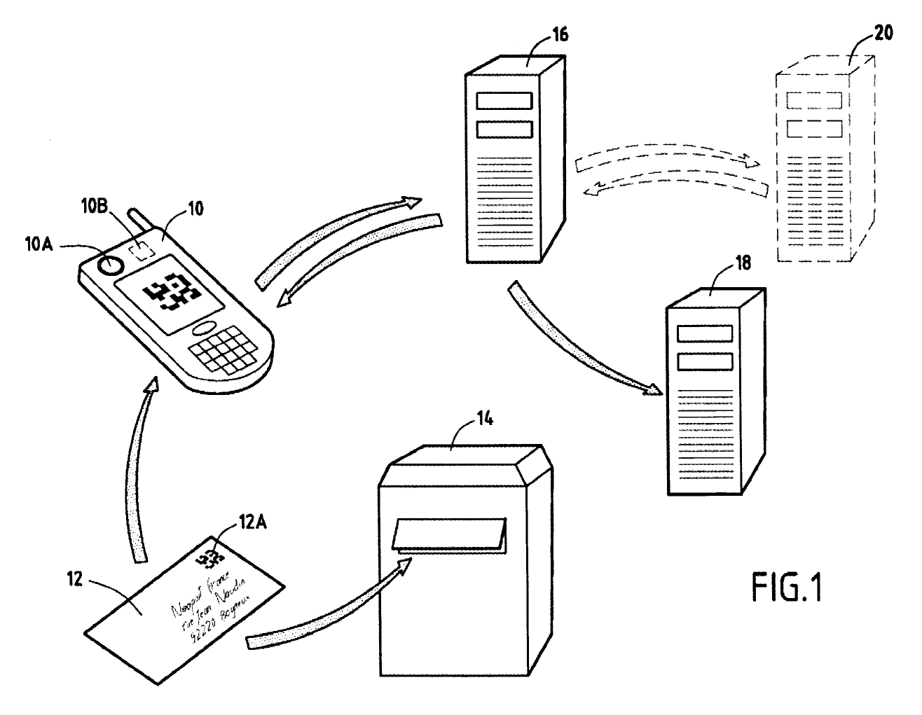

FIG. 1 illustrates an example of a network architecture necessary to put into effect the method of obtaining a franking credit according to the invention. It is based on the use of a portable communications device 10 that is used to obtain and pay for a franking credit related to a mail item 12 which it is desired to send via any post box 14 of the postal authority. The expression mail item is understood to mean not only an envelope but also a label intended to be affixed to any type of package to be mailed.

To carry out the method of the invention, this mail item is firstly provided with a unique identification number 12A, preferably sequential or of the random non-reusable type, which was printed during the process of creating the mail item, which ensures the printing quality thereof, and the uniqueness of which ensures that two mail items cannot under any circumstances bear the same number. In an alternative embodiment, this unique identification number can be stored in a contactless chip, or RFID tag, carried by the mail item or its contents. It is important to note that in contrast to a stamp or a postmark of a franking machine, this number does not represent any franking value and therefore does not contain any monetary value.

When it is printed, this unique identification number is advantageously presented in the form of a code with a high capacity for coding digital or alphanumeric data and error correction, such as two-dimensional barcodes of which the best known are: Aztec code, Codablock, Code one, Code 16K, Code 49, data matrix, PDF 417, QR Code, or Supercode. The high coding capacity of this type of code (including up to 4296 characters at the higher end) thus makes it possible for the code to include not only the identification number but also other information relating to the mail item, such as a format reference in the case of an envelope or a manufacturer's number and a country code, such as recommended by the EPC (Electronic Product Code) standard developed by the standardisation organisation of the same name.

In the process of obtaining a franking credit, the portable communications device is placed in communication with a franking credits delivery server system 16, this server being in turn capable of connecting to a postal authority server system 18 and optionally to a telephone operator server system 20 which, as the case may be, debits the requested franking credit directly from the telephone account which may be held by the user of the portable communications device.

The portable communications device 10 is any data processing device enabling long distance wireless communications via a terrestrial or satellite wireless telecommunications network (such as the GSM, UMTS, WiMax networks, etc.) such as a mobile or portable telephone, a web-enabled personal digital assistant or a web-enabled portable computer. In the embodiment envisaged, it can include a digital capture device 10A, such as a digital camera or a two-dimensional barcode reader, or a contactless chip reading/interrogation module 10B designed to cooperate with a transponder (RFID tag) carried by the mail item or its contents when they are therewith provided.

The server system 16 located at a site of the franking credits provider includes one or more central processing units comprising one or more databases and the control and management thereof are accomplished in the conventional manner by one or more computer terminals (not shown). The server system 18 of the postal authority includes a similar structure with one or more databases, in particular a database of the identification numbers. Similarly, the server system 20 of the telephone operator includes a similar structure with one or more databases, in particular a customer database containing accounting data.

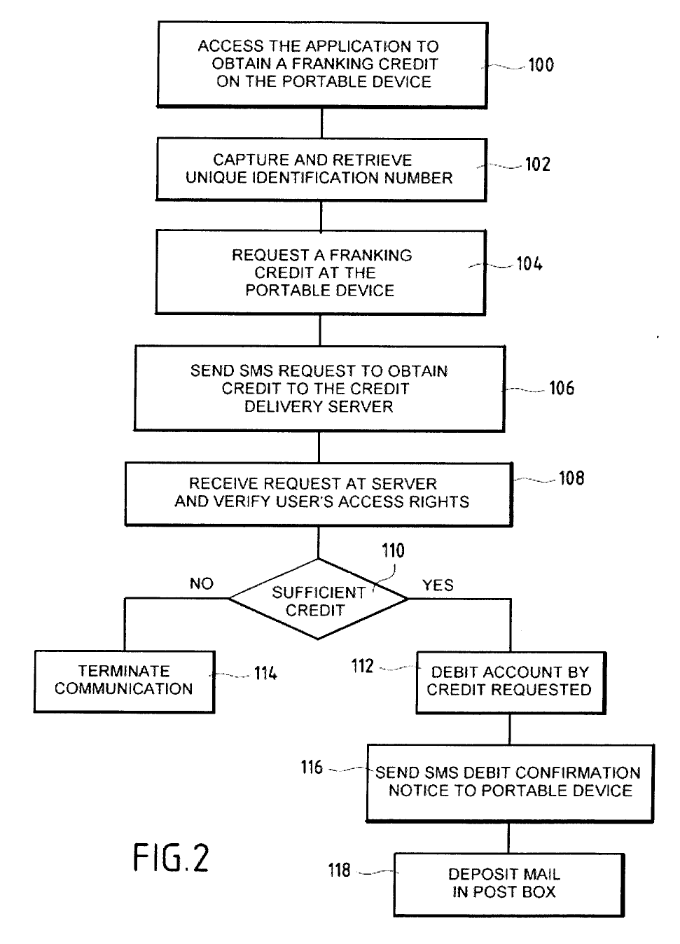

FIG. 2 shows a block diagram illustrating the different steps of the method of obtaining a franking credit requested by a user.

In a first step 100 of putting the method into effect, the user wishing to send a pre-printed mail item 12 which he/she has previously acquired will click on the icon of the franking application pre-installed on his/her portable communications device. This action will automatically activate the digital capture function of this device thereby enabling the user by means of the digital capture device 10A to enter at a step 102 an image of the 2D-barcode affixed to the pre-printed mail item, acceptance of the entry of this image by pressing a capture button (not shown) on the portable communications device causing the immediate decoding of the code entered, i.e. retrieval of the unique identification number contained in this code.

It will be noted that when the mail item is provided with an RFID tag, the digital capture function will automatically retrieve the identification number from this tag by means of the reading/interrogation module 10B with no particular activating action by the user other than placing the portable communications device in proximity to the mail item.

At a next step 104, the portable communications device will then prompt the user via its display screen to indicate the franking credit that he/she wishes to use to send the pre-printed mail item. The value of this franking credit, which is dependent on the service(s) requested (priority or economy for example), the geographical area of the destination (national or abroad) and the weight class of the mail item, is left to the sole responsibility of the user who will therefore need to have at his/her disposal the different postal tariffs in force at the date of mailing. By way of example, to send a letter weighing less than 20 grams to the United States at the priority rate the user would need to request a credit of 0.90 Euros, while to send a package weighing 8 kg overseas at the economy rate the user would need to request a credit of 14 Euros.

At a step 106, the portable communications device will then send to the franking credits delivery server 16 a request to obtain a corresponding franking credit in the form of a short message (SMS) containing this credit and the identification number previously retrieved.

At a further step 108, the server 16 will receive this request and based on the telephone number of the portable communications device (obtained in a conventional manner from the IMSI or IMEI numbers of the portable communications device transmitted during the call) will verify the user's access rights and, if the user's account has sufficient available funds (yes response to the test at step 110), will debit the user's customer account by the corresponding amount at step 112. If not, it will then invite the user to top up his/her credit and the communication will then be terminated (step 114) and the user may not then post the mail item without rendering its recipient liable to pay the franking cost plus a fine.

If, however, the user does not have a customer account with the franking credits delivery server, the latter will forward the requested credit value and the telephone number of the portable communications device associated therewith to the telephone operator server 18 which can then in turn check, by accessing its own customer database, whether the user's account has sufficient telephone credit to pay the cost of the franking credit requested. If the telephone operator considers that the user has insufficient credit it will inform the credit provider accordingly and the latter will then invite the user to top up his her/her credit and the communication will then be terminated (step 114).

Otherwise, if the user's access rights are validated (sufficient credit with the telephone operator) and his/her account is then debited by the corresponding amount at step 112, the server 16 will generate at step 116, in response to the request to obtain a franking credit, a credit confirmation notice and will send it to the portable communications device in the form of an SMS message.

Having been notified that the credit has been obtained and that his/her account has been debited accordingly, the user can then without any other formality deposit the mail item in the post box 14 at a final step 118.

At the end of each day, preferably in the last few minutes, the franking credits delivery server 16 will transfer to the postal authority server 20, all of the data (identification number and associated credit) relating to the credit operations completed that day or, more simply, will grant it access rights to all of this data.

Thus, with the present invention, any user can in a very simple manner send any mail item, be it an envelope or a package, to any destination without having to visit an office of the postal authority, the unique identification number (which replaces the stamp or postmark of a franking machine and plays the role thereof although it has no monetary value) carried on each mail item being sufficient for the postal authority to process the item.

In effect, when the mail item is deposited at one of its receiving offices, the postal authority will on the one hand optically scan the mail item to retrieve the identification number and recipient's address (to determine the destination zone), and optionally the class of service where this is pre-printed on the mail item for example “priority”, and on the other hand will weigh this mail item to determine its weight class and, based on this information, will calculate the necessary franking value for this mail item. It will only then remain to check that the credit paid by the user and associated with the identification number retrieved from the mail item is at least equal to the calculated franking value in order to authorise the distribution thereof to its recipient. If the credit is insufficient, the postal authority will calculate the extra payment that will have to be remitted by the recipient in order to receive the mail item.

It will be noted that while the present invention has been described essentially with reference to a mail item provided with an identification number of the 2D-barcode type, it can be envisaged in a more simplified version that this number is a simple alphanumeric code formed by a string of one or several tens of alphanumeric characters machine-readable by means of an OCR reader or simply entered directly by the user via the keypad of his/her portable communications device.

1. Method of obtaining a franking credit, characterised in that it includes the following operations:
entry via a user's portable communications device (10) of a unique identification number (12A) carried by a mail item (12) in the user's possession,
entry of a franking credit at the portable communications device and transmission of the franking credit thus requested to a franking credits delivery server (16),
debiting the user's account by an amount corresponding to the franking credit requested and transmission by the franking credits delivery server of a debit confirmation to the user's portable communications device, and
depositing the mail item in a post box (14).

2. Method according to claim 1, characterised in that the operation of entering said unique identification number includes a manual entry via the keypad of the portable communications device of a string of alphanumeric characters printed on the mail item and forming this unique identification number.

3. Method according to claim 1, characterised in that the operation of entering said unique identification number includes a digital capture (10A) by the portable communications device of a barcode printed on the mail item.

4. Method according to claim 3, characterised in that said barcode is a two-dimensional code selected from the following codes: Aztec code, Codablock, Code one, Code 16K, Code 49, data matrix, PDF 417, QR Code, Supercode.

5. Method according to claim 1, characterised in that the operation of entering said unique identification number includes a reading/interrogation (10B) by the portable communications device of an RFID tag carried by the mail item or its contents.

6. Method according to claim 1, characterised in that the operation of sending a franking credit to the franking credits delivery server from the portable communications device includes the transmittal of an SMS message including the requested franking credit.

7. Method according to claim 1, characterised in that the operation of debiting the user's account includes a check of available funds in the user's account at the franking credits delivery server or a check of the user's telephone credit at a server (20) of the user's telephone operator.

8. Method according to claim 7, characterised in that the operation of sending a debit confirmation to the user's portable communications device from the franking credits delivery server includes the transmittal of an SMS message including the debited amount of the franking credit requested.

9. Portable communications device (10) intended to put into effect the method of obtaining a franking credit according to any one of claims 1 to 8.

10. Device according to claim 9, characterised in that it is comprised of one of the following devices: a mobile or portable telephone, a web-enabled personal digital assistant, a web-enabled portable computer.

11. Computer program including code instructions for performing the steps of the method of obtaining a franking credit according to any one of claims 1 to 8 when it is executed on the portable communications device.
